(19) United States
(12) Patent Application Publication
(10) Pub. No.: US 2003/0204535 A1
(43) Pub. Date: Oct. 30, 2003

(54) File management device

(75) Inventor: Kazuyoshi Harada, Osaka (JP)

Correspondence Address: ARMSTRONG,WESTERMAN & HATTORI, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/421,875

(22) Filed: Apr. 24, 2003

(30) Foreign Application Priority Data
Apr. 26, 2002 (JP) 2002-126317

(51) Int. Cl. G06F 12/00

(52) U.S. Cl. 707/200

(57) ABSTRACT

The present invention provides a file management device wherein a plurality of recording data files and a file management table including a file name and block information of each of the recording files are recorded on a hard disk device 4. A system controller 8 gradually reduces the size of a recording data file specified to be deleted by clearing the block information of the file management table by every predetermined number of blocks for reduction, and deleting the recording data file from the hard disk device 4 by finally clearing the file name of the file management table.

### FIELD OF THE INVENTION

The present invention relates to devices for performing file management of disk devices such as hard disk devices which are adapted to record each of a plurality of recording data files as divided into blocks.

### BACKGROUND OF THE INVENTION

With conventional devices for recording and reproducing video and voice data (hereinafter referred to as recording data) using hard disk devices, the hard disk devices have limited memory capacity, so that an unnecessary recording data file needs to be deleted at a suitable time, and memory capacity needs to be reserved.

In the case where the recording data is encoded, for example, at bit rate of 8 Mbps, the size of the data is about 3.6 G bytes when the data is recorded for an hour at 1 M byte per second. When such recording data is stored on a hard disk device, the recording data is managed as a file by a file management system of the recording reproduction device based on recording data location on the hard disk and occupied sector information.

Accordingly, in the case where unnecessary recording data file is deleted from the hard disk device, the location and the occupied sector information as described above need to be cleared (be made empty space), and the processing for the clearance takes a long period of time.

Further, when application or firm ware demands to delete a file, and particularly the file to be deleted is large in size, CPU is exclusively occupied by the file delete processing. At this time, if the file delete and recording/reproduction of another recording data file are executed concurrently, there arise the problems of interruption of the recording/reproduction processing and the occurrence of reproduced image disturbance.

It is a conventional practice that the delete processing is not executed right after the file delete is instructed, but a delete marking is appended to a file to be deleted and thereafter the file delete processing is actually executed in power off sequence and in the subsequent power on sequence of the recording reproduction device. Furthermore, it is also a conventional practice that the file delete processing is executed only when the recording processing or the reproduction processing is not executed.

However, the file delete processing is executed when the recording reproduction device is in the power off sequence or in the power on sequence, entailing a problem that the processing for turning power on or off takes much time. Further, in the case where the file delete processing is executed only when the recording processing and the reproduction processing are not executed, it is an inconvenience that the file delete processing has to be executed after the completion of recording and reproduction.

### SUMMARY OF THE INVENTION

An object of the present invention is to provide a file management device wherein file delete processing does not cause interruption of recording/reproduction processing of a recording data file or the abnormality of the reproduced image, and processing for turning power on or off does not take much time.

A file management device of the invention comprises:

means for specifying a file to be deleted from among a plurality of recording data files recorded on a disk device,

file management table means for storing a file name of each of the plurality of recording data files recorded on the disk device and block information for specifying a plurality of blocks wherein data of the file is recorded,

file delete means for gradually reducing the size of a recording data file specified to be deleted by clearing the block information of the file management table means by every predetermined number of blocks for reduction, and deleting the recording data file from the disk device by finally clearing the file name of the file management table means.

For example, the file delete means clears the block information of the file management table means by every predetermined number of blocks for reduction in concurrent with the recording/reproduction processing to the disk device, specifically stated, utilizing idle time of the recording/reproduction processing.

With the file management device of the present invention, the delete processing of the recording data file at a time as conventionally practiced is not executed, but the processing is executed as divided at a plurality of times. The processing at one time is only clearing the block information of the file management table means by the predetermined number of blocks for reduction, so that the processing takes extremely a short period of time.

Accordingly, if the file delete processing and the recording/reproduction processing are executed concurrently, the file delete processing at one time can be executed by utilizing the idle time of the recording/reproduction processing, to thereby avoid the interruption of the recording/reproduction processing and the reproduced image disturbance.

According to the specific construction of the invention, the file management device comprises means for detecting empty space capacity of the disk device and determining whether the detected empty space capacity becomes below a predetermined threshold value. When the detected empty space capacity is below the predetermined threshold value, the file delete means starts a file delete procedure as for a recording data file specified to be deleted. Accordingly the file delete procedure of the invention is executed at a starting time when the empty space capacity of the disk device becomes below the predetermined value.

Stated specifically, the block information of the file management table means comprises a set of block specifying data including a starting block number and the number of blocks as for consecutive blocks wherein at least one part of data of a recording data file is recorded. When the number of blocks included in the block specifying data to be cleared is below the predetermined number of blocks for reduction, the file delete means clears the block specifying data by the predetermined number of blocks for reduction. When the number of blocks included in the block specifying data to be cleared is greater than the predetermined number of blocks for reduction, the file delete means clears the block specifying data by the number of the predetermined number of blocks for reduction and including one or more pieces of block specifying data which are next to the block specifying data. Thus the file delete processing is always performed with units of the constant number of blocks for reduction, so that processing time taken for one time can be reduced to not greater than a certain period of time.

As described above, with the file management device of the invention, a recording data file specified to be deleted is gradually reduced in size, and the recording data file is finally deleted from the disk device, so that time required for the file delete is dispersed. Therefore, the file delete processing will not interrupt the recording/reproduction processing of the recording data file, or will not cause the reproduced image disturbance, and moreover on/off processing of the power source will not take unnecessary time.

### BRIEF DESCRIPTION OF THE DRAWINGS

FIG. 1 is a block diagram showing the construction of a recording reproduction device of the present invention;

FIG. 2 is a flow chart showing a file delete procedure when the recording reproduction device starts recording/reproduction;

FIG. 3 is a flow chart showing user's manipulation processing;

FIG. 4 is a flow chart showing processing for reducing file size;

FIG. 5 is a flow chart showing recording file delete processing;

FIG. 6 is a flow chart showing processing for updating a space management bit table;

FIG. 7 is a flow chart showing the first half of another file delete procedure upon starting recording/reproduction;

FIG. 8 is a flow chart showing the second half of the file delete procedure described;

FIG. 9 is a flow chart showing user's manipulation processing of the file delete procedure;

FIG. 10 is a diagram describing data construction to the hard disk device;

FIG. 11 is a diagram describing a processing loop for repeating write and read of a file in the hard disk device.

### DETAILED DESCRIPTION OF EMBODIMENTS

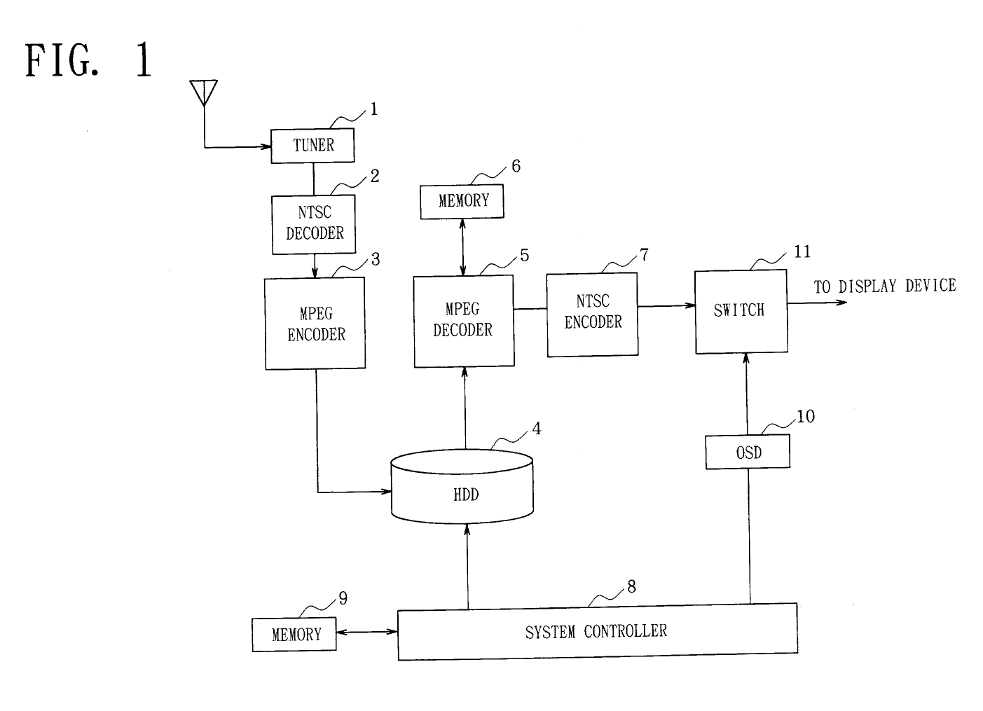

The present invention as embodied into a recording reproduction device shown in FIG. 1 will be described in detail with reference to the drawings. The recording reproduction device of the invention comprises, as shown in FIG. 1, a hard disk device 4 having a hard disk. A system controller 8 controls the operation of the hard disk device 4.

The recording reproduction device of the invention comprises a tuner 1. Video contents received by the tuner 1 are converted to digital data by an NTSC decoder 2, the converted digital data is further converted to MPEG data by an MPEG encoder 3, and thereafter the MPEG data is recorded as recording data on the hard disk device 4.

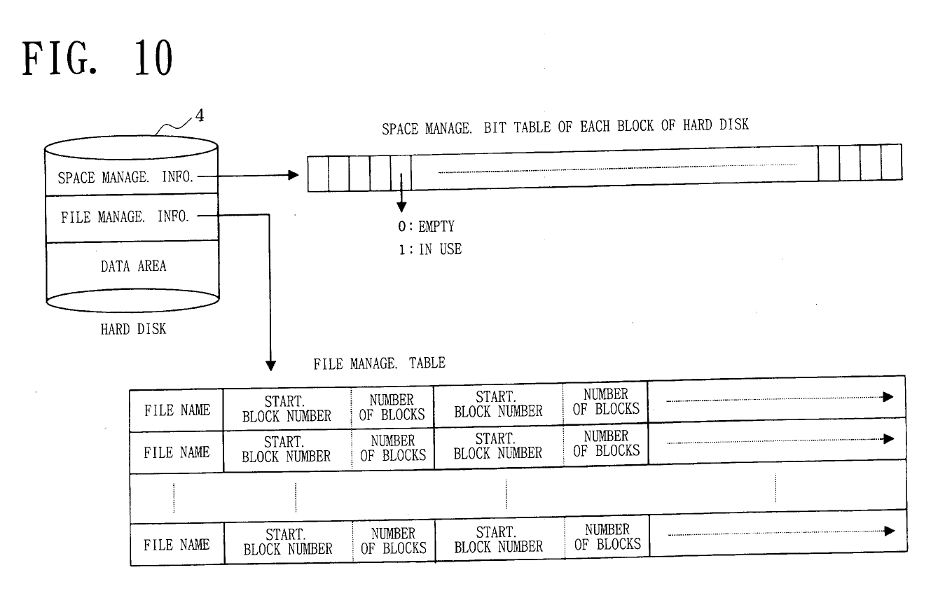

The hard disk device 4 is provided with space management information, file management information, and data record area, as shown in FIG. 10. Written as the space management information is a table including space management bit (0:empty, 1:in use) of each of blocks in the hard disk. Written as the file management information is a file management table as for a plurality of recording data files recorded on the hard disk. The file management table comprises a file name and a set of block specifying data including pairs of the starting block number and the number of blocks as for each of the plurality of recording data files. The starting block number indicates the head block number among a plurality of blocks wherein data of one recording data file is consecutively recorded. The number of blocks indicates the number of the consecutive blocks.

In recording to the hard disk 4, recording data is output by the MPEG encoder 3, a file name is registered in the file management table for storing the recording data as a file on the hard disk device 4, an empty block is subsequently searched from the space management bit table, and the recording data is written to the empty block searched. Data of the space management bit table corresponding to the block written to is rewritten into in use.

The recording data thus written to the hard disk device 4 is read out according to a user's command. The read out data is fed through the MPEG decoder 5 to the NTSC encoder 7 to be converted to an NTSC signal to thereafter output through a switch 11 to a display device which will be described below, as shown in FIG. 1;

Connected to the MPEG decoder 5 is a memory 6 used for MPEG decoding. Connected to the system controller 8 is a memory 9 wherein a file management procedure which will be described below is written. Various information including the file names of a plurality of recording data files recorded on the hard disk device 4 is output via the system controller 8, an on-screen display circuit 10, and the switch 11 to the display device which will be described below to be on-screen displayed.

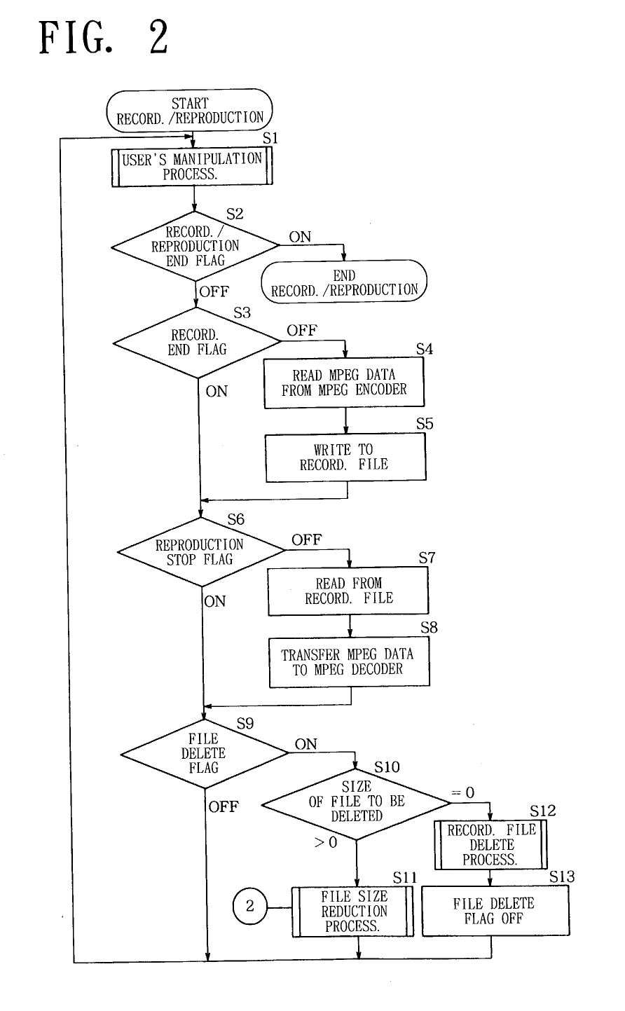

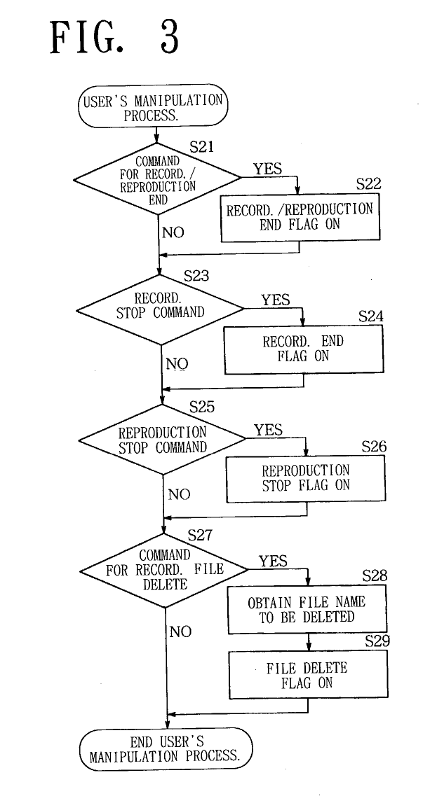

FIG. 2 shows a procedure executed by the system controller upon the start of recording/reproduction. First in step S1 user's manipulation processing is executed according to the user's command manipulation. In the user's manipulation processing, step S21 inquires whether a command for the end of recording/reproduction is given, as shown in FIG. 3. If the answer is affirmative, step S22 follows to turn on a recording/reproduction end flag. Subsequently in step S23, an inquiry is made whether a recording stop command is given. When the answer is affirmative, a recording stop flag is turned on in step S24. Next in step S25, an inquiry is made whether a reproduction stop command is given. If the answer is affirmative, step S26 follows to turn on a reproduction stop flag.

Step S27 further inquires whether a command for deleting the recording file is given. When the answer is affirmative, step S28 follows to obtain a file name to be deleted. In step S29 a file delete flag is turned on, to end the user's manipulation processing.

Subsequently in step S2 shown in FIG. 2, an inquiry is made whether the recording/reproduction end flag is turned on or off. If the flag is turned on, the recording/reproduction is ended. If the flag is turned off, step S3 follows to inquire whether a recording stop flag is turned on or off. When the flag is turned off, step S4 follows to read MPEG data from an MPEG encoder, and to thereafter write the read MPEG data to a recording file in step S5.

In step S6, an inquiry is made whether the reproduction stop flag is turned on or off. When the flag is turned off, step S7 follows to read MPEG data from the recording file, and to transfer the read MPEG data to an MPEG decoder in step S8.

Step S9 thereafter inquires whether the file delete flag is turned on or off. If turned on, step S10 follows to inquire whether the file to be deleted is zero or greater than zero in size. When the file is greater than zero in size, step S11 executes file-size reduction processing which will be described below. On the other hand, when the file is zero in size, recording file delete processing which will be described below is executed in step S12, and the file delete flag is then turned off in step S13. Thereafter, the sequence returned to step S1 to repeat the same procedure.

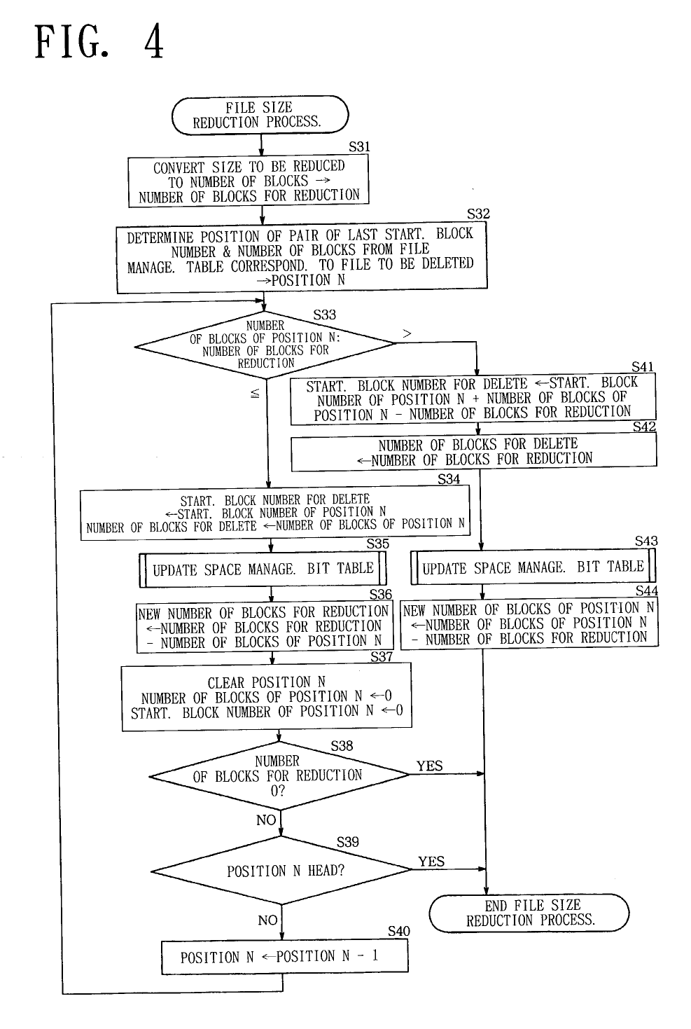

In reducing the file size of the step S11 described, as shown in FIG. 4, in step S31 the size to be reduced is converted into the number of blocks according to the file-size reduction processing, and the conversion result is set as the number of blocks for reduction. Next step S32 determines a position of a pair of the last starting block number and the number of blocks from the file management table corresponding to the file to be deleted, and the resulted position is set as a position N.

Step S33 compares the number of blocks of the position N with the number of blocks for reduction. When the number of blocks of the position N is not greater than the number of blocks for reduction, the starting block number of the position N is set as the starting block number for delete and the number of blocks of the position N is set as the number of blocks for delete in step S34. Step S35 executes an update processing of the space management bit table which will be described below.

In the update processing of the space management bit table of the step S35, step S62 sets a counter C to one and the starting block number for delete is set as the delete block number as shown in FIG. 6. In step S63 the counter C and the number of blocks for delete are compared. When the counter C is not greater than the number of blocks for delete, step S64 follows to set to zero the bit in the space management table corresponding to the delete block number. Subsequently in step S65, the delete block number is advanced and the counter C is also advanced. Thereafter the sequence returns to step S63. In step S63, when the counter C is greater than the number of blocks for delete, updating the space management bit table is completed.

In step S35 shown in FIG. 4, updating the space management bit table is completed, followed by step S36 to subtract the number of blocks of the position N from the number of blocks for reduction, setting the subtraction result as the new number of blocks for reduction. Then step S37 follows to clear the position N, set to zero the number of blocks of the position N, and set to zero the starting block number of the position N.

An inquiry is made whether the number of blocks for reduction is zero in step S38. If the answer is negative, step S39 follows to inquire whether the position N is a head. When the answer is negative, step S40 follows to decrement the position N and thereafter returns to step S33. Thereafter when the answer for step S38 is affirmative or the answer for S39 is affirmative, file-size reduction processing is completed.

On the other hand, when the number of blocks of the position N is greater than the number of blocks for reduction in step S33, step S41 follows to subtract the number of blocks for reduction from the value obtained by adding the starting block number of the position N to the number of blocks of the position N, and the subtracted result is set as the starting block number for delete. Subsequently in step S42, the number of blocks for reduction is set as the number of blocks for delete. In step S43, updating the space management bit table as described above is executed (FIG. 6). Then step S44 follows to subtract the number of blocks for reduction from the number of blocks of the position N, setting the result as the new number of blocks of the position N, to complete the file size reduction processing. Accordingly the recording file to be deleted is gradually reduced in size.

In deleting the recording file of step S12 shown in FIG. 2, a part of a file name of the file management table corresponding to the file name concerned is zero-cleared, completing the delete processing of the recording file. As a result, the recording file is entirely deleted.

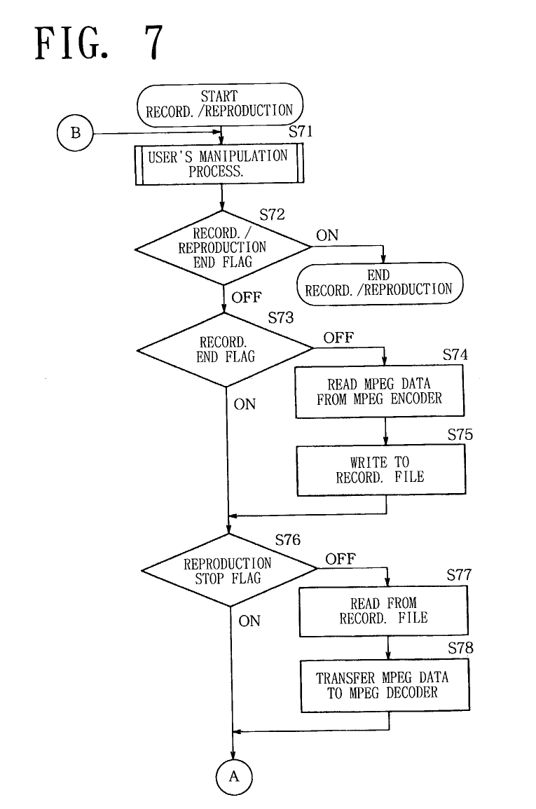

FIG. 7 shows another procedure executed by the system controller upon the start of recording/reproduction. First in step S71, user's manipulation is processed according to the user's command manipulation. In the user's manipulation processing, step S91 inquires whether a command for the end of recording/reproduction is given, as shown in FIG. 9. If the answer is affirmative, step S92 follows to turn on a recording/reproduction end flag. Subsequently in step S93, an inquiry is made whether a recording stop command is given. When the answer is affirmative, a recording stop flag is turned on in step S94. Next in step S95, an inquiry is made whether a reproduction stop command is given. If the answer is affirmative, step S96 follows to turn on a reproduction stop flag.

Step S97 further inquires whether a command for deleting the recording file is given. When the answer is affirmative, step S98 follows to obtain a file name to be deleted. In step S99 an automatic file delete flag is turned on, to end the user's manipulation processing.

Subsequently in step S72 shown in FIG. 7, an inquiry is made whether the recording/reproduction end flag is turned on or off. If the flag is turned on, the recording/reproduction is ended. If the flag is turned off, step S73 follows to inquire whether a recording stop flag is turned on or off. When the flag is turned off, step S74 follows to read MPEG data from an MPEG encoder, and to thereafter write the read MPEG data to a recording file in step S75.

In step S76, an inquiry is made whether the reproduction stop flag is turned on or off. When the flag is turned off, step S77 follows to read MPEG data from the recording file, and to transfer the read MPEG data to an MPEG decoder in step S78.

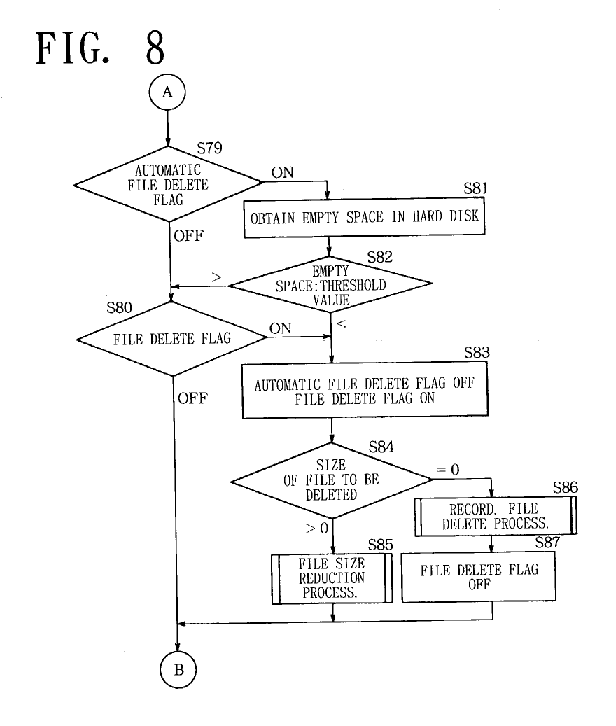

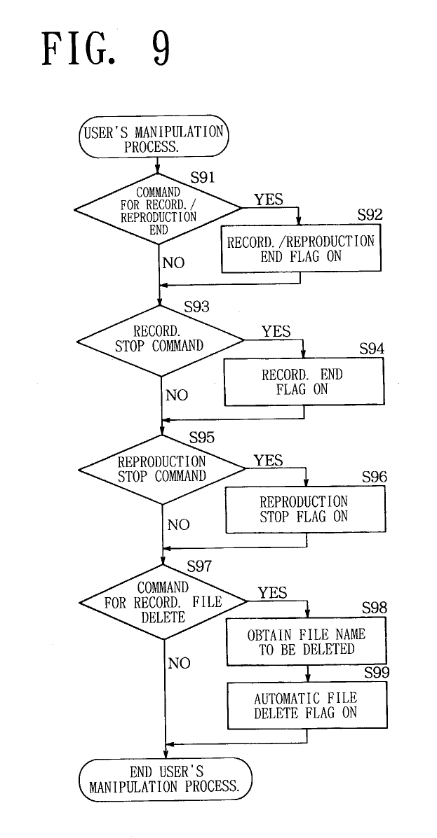

Step S79 shown in FIG. 8 thereafter inquires whether an automatic file delete flag is turned on or off. If turned on, step S81 follows to obtain empty space in the hard disk and to thereafter compare the empty space with a predetermined threshold value in step S82. When the empty space is greater than the threshold value, step S80 follows to inquire whether the file delete flag is turned on or off. When turned off, the sequence returns to step S71 shown in FIG. 7.

When the empty space is not greater than the threshold value in step S82 shown in FIG. 8, or when the file delete flag is turned on in step S80, step S83 follows to turn off the automatic file delete flag and to turn on the file delete flag.

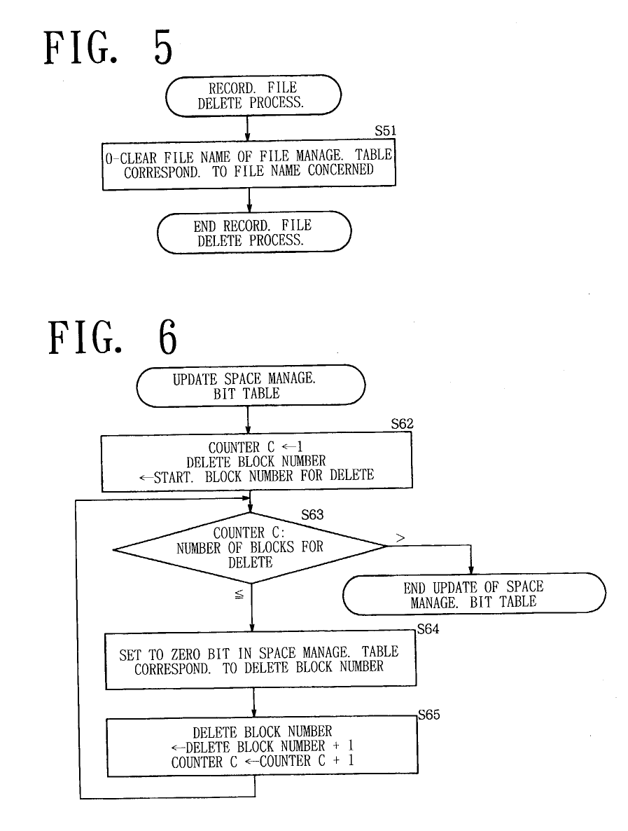

Subsequently step S84 inquires whether the file to be deleted is zero or greater than zero in size. When the file is greater than zero in size, step S85 follows to execute the file-size reduction processing described (FIG. 4). When the file is zero in size, the recording file delete processing described (FIG. 5) is executed in step S86, and the file delete flag is then turned off in step S87. Thereafter, the sequence returned to step S71 to repeat the same procedure.

According to the procedures shown in FIGS. 7 and 8, the file delete procedure is executed at a starting time when the empty space capacity of the hard disk becomes below the predetermined value.

With the recording reproduction device of the invention, in the case where the recording data file of up to several G bytes is deleted from the hard disk during the recording processing or reproduction processing executed, the file size concerned is gradually reduced to finally delete the entire file concerned while the recording processing or reproduction processing is not interrupted. Accordingly, the conventional problem with the recording processing and the reproduction processing is not encountered.

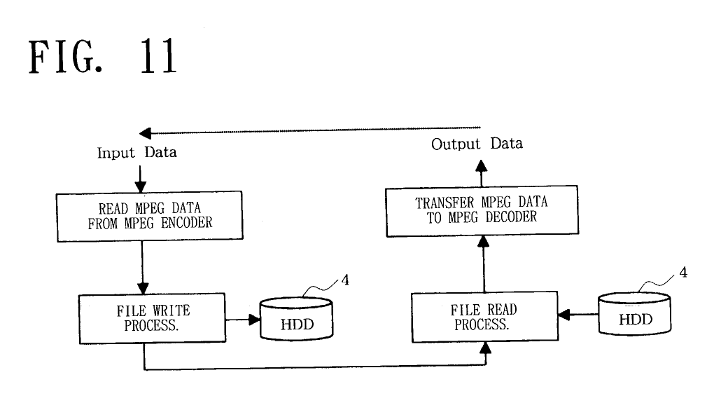

For example, as shown in FIG. 11, in the case where the recording reproduction device repeats a processing loop comprising a processing for reading the MPEG data from the MPEG encoder and writing a file to the hard disk device 4, and a processing for reading a file from the hard disk device 4 and transferring MPEG data to the MPEG decoder, there is a need to make one turn around the processing loop within 125 ms when the MPEG data is read with units of 128 K bytes using the bit rate of 8 Mbps.

In the process of file writing, it takes around 50 ms to write data of 128 K bytes with the system having a CPU of about 200 MIPS using Ultra DMA Mode2 on the hard disk connected to IDE interface. On the other hand, in the process of reading file, it takes around 30 ms to read data of 128 K bytes. Accordingly, the sum of 50 ms and 30 ms is subtracted from 125 ms, producing 45 ms of spacing time, so that the user's manipulation and OSD display are processed within the spacing time.

If a recording data file having an hour and a few more length is given and has a capacity of about 4 G bytes, one million blocks are occupied when a block size of the hard disk is 4 K bytes. Further, the space management bit table of the hard disk requires one million bits, which correspond to 30 blocks in the number of blocks. This corresponds to 120 K bytes, which are comparable to the MPEG data of 128 K bytes handled in the processing loop described above.

In the case where the recording file of 4 G bytes is to be deleted, it is required to read the space management bit table by 120 K bytes to be zero-cleared and written back. Writing the MPEG data of 128 K bytes is approximately equivalent to reading the data of 128 K bytes in terms of processing time.

That is, it is estimated that 80 ms is required in total, which goes beyond the spacing time for the processing loop of 45 ms. If the file delete processing is incorporated into the processing loop, data from the MPEG encoder cannot be read within 125 ms, with the result that the MPEG data cannot be stored in a file normally. Further, the MPEG data cannot be supplied to the MPEG decoder within 125 ms, whereby the image displayed is disturbed.

On the other hand, the present invention makes it possible to clear the space management bit table of the hard disk occupied by the file to be deleted, for example, by 12 K bytes which are equal to 1/10 of the case described above, i.e., to reduce file size by 400 M bytes as converted in file size. Thus, said clear processing can be completed within the spacing time of 45 ms. As a result, even incorporating said clear processing into the processing loop will never affect the recording/reproduction processing of the MPEG data.

The device of the present invention is not limited to the foregoing embodiments in construction but can be modified variously by one skilled in the art without departing from the spirit of the invention as set forth in the appended claims.

What is claimed is:

1. A file management device for performing file management of a disk device being adapted to record each of a plurality of recording data files as divided into blocks, the file management device comprising:
means for specifying a file to be deleted from among the plurality of recording data files recorded on the disk device,
file management table means for storing a file name of each of the plurality of recording data files recorded on the disk device and block information for specifying a plurality of blocks wherein data of the file is recorded,
file delete means for gradually reducing the size of the recording data file specified to be deleted by clearing the block information of the file management table means by every predetermined number of blocks for reduction, and deleting the recording data file from the disk device by finally clearing the file name of the file management table means.

2. A file management device according to claim 1 wherein the file delete means clears the block information of the file management table means by every predetermined number of blocks for reduction in concurrent with recording/reproduction processing to the disk device.

3. A file management device according to claim 1 wherein the file delete means clears the block information of the file management table means by every predetermined number of blocks for reduction during idle time of the recording/reproduction processing to the disk device.

4. A file management device according to claim 1 wherein the file management device further comprises means for detecting empty space capacity of the disk device and determining whether the detected empty space capacity becomes below a predetermined threshold value, and the file delete means starts a file delete procedure as for the recording data file specified to be deleted when the detected empty space capacity is below the predetermined threshold value.

5. A file management device according to claim 1 wherein the block information of the file management table means comprises a set of block specifying data including a starting block number and the number of blocks as for a plurality of consecutive blocks wherein at least one part of data of one recording data file is recorded, the file delete means clears the block specifying data by the predetermined number of blocks for reduction when the number of blocks included in the block specifying data to be cleared is below the predetermined number of blocks for reduction, and the file delete means clears the block specifying data by the number of the predetermined number of blocks for reduction and including one or more pieces of block specifying data which are next to the block specifying data when the number of blocks included in the block specifying data to be cleared is greater than the predetermined number of blocks for reduction.
